(19) United States
(12) Patent Application Publication
(10) Pub. No.: US 2023/0388107 A1
(43) Pub. Date: Nov. 30, 2023

(54) SYSTEM AND METHOD FOR ENCRYPTED MULTIMEDIA INFORMATION MANAGEMENT

(71) Applicant: Lien Hao Chuang, Kaohsiung City (TW)

(72) Inventor: Lien Hao Chuang, Kaohsiung City (TW)

(21) Appl. No.: 17/899,917

(22) Filed: Aug. 31, 2022

(30) Foreign Application Priority Data
May 27, 2022 (TW) 111122505

(51) Int. Cl. H04L 9/08; H04L 9/32; G06F 21/62; G06F 16/435; G06K 19/077

(52) U.S. Cl. CPC H04L 9/0825; H04L 9/3228; G06F 21/6209; G06F 16/435; G06K 19/07705

(57) ABSTRACT

System and method for encrypted multimedia information management, wherein the first user scans a sensing device with the first information device to retrieve an identification code. The first information device generates a public key based on the identity of the second user and encrypts the multimedia information to be sent to the second user. The encrypted multimedia information is then uploaded to the server together with the identification code and the set time conditions for the second encryption. When the second user reads the multimedia information, the second information device is used to scan the sensing device to obtain the identification code. Based on the identity feature, the second information device generates the private key corresponding to the public key. After generating a key based on the current time point, the multimedia information is decrypted for the first time and the second time to obtain the multimedia information.

### BACKGROUND OF INVENTION

### (1) Field of the Present Disclosure

The present disclosure relates to a system and a method for encrypted multimedia information management, and more particularly to a management system for encrypted multimedia information which can only be opened/read within a specific time point and a method thereof.

### (2) Brief Description of Related Art

With the development of science and technology, the use of multimedia information to convey information (for celebrating birthdays by shooting birthday videos, or recording wills with multimedia information media in combination of text wills) has replaced the previous way of text communication. The prior art includes: (1) Patent Publication No. TW201933149A which comprises a service platform, a cloud database, and an interactive database. The service platform can be accessed by the user. The cloud database is stored with contract signed by the contractor during his lifetime, original audio-visual data uploaded by the user, and the virtual real image audio-visual data compiled by post-processing the encoded audio-visual data. (2) Patent Publication No.: TW200943089A, a sacrificial image management system and method; (3) Patent Publication No.: CN113034328A, an information storage device.

However, the above-mentioned disclosures of the prior art are all provided for the parties who want to present the recorded content to each specific object at a specific time and situation. Therefore, how to enable objects to obtain and read multimedia information content effectively and under certain time conditions is still a big problem at present. In addition, for multimedia information content involving rights and privacy, such as wills, confidentiality, etc., especially in the current situation where information security breaches are unavoidable, how to prevent the leakage of multimedia information content is an important issue. Therefore, how to enable the multimedia information content to be opened in a well-encrypted and protected manner within a specific time interval is an urgent problem to be solved.

### SUMMARY OF INVENTION

It is a primary object of the present disclosure to provide a system and a method for encrypted multimedia information management, wherein the system includes a sensing device, a first information device, a second information device, and a server. The system for encrypted multimedia information management can be used when a first user wants a second user to receive and watch a multimedia information (recorded by the first user) at a specific time point. The multimedia information can include text, numbers, audio, video, video streaming, etc. The first user can scan the sensing device with the first information device to obtain an identification code of the sensing device. The first user then uses the first information device to set a time condition (that is, a specific time point viewed by the second user), and an identity feature of the second user. The first information device uses the identity feature to generate a public key and encrypts the multimedia information for the first time. Thereafter, the identification code, the time conditions, and the multimedia information are uploaded to the server. At this time, the multimedia information corresponds to the identification code. Meanwhile, a key is generated by using the identification code and the time condition to encrypt the multimedia information for the second time. When the second user wants to view the multimedia information, the second information device is used to scan the sensing device for obtaining the identification code. Meanwhile, the second information device is used to input the identity feature to generate a private key corresponding to the public key. Thereafter, the private key, the identification code, and a current time point are uploaded by the second information device to the server. The successful decryption means that the multimedia information is requested to be opened at the correct time. After completing the first decryption, the server performs the second decryption with the private key. If the decryption is successful, it also means that it is the correct second user information. Meanwhile, it can be determined that the recipient is not the person who misappropriated the information. In this way, it is achieved that the multimedia information is opened by a designated user at a specific time point.

### BRIEF DESCRIPTION OF THE DRAWINGS

FIG. 1 is a block diagram of the system structure of the present disclosure;

FIG. 2 is a flow chart I of the present disclosure;

FIG. 3 is a flow chart II of the present disclosure;

FIG. 4 is a schematic diagram I of the implementation of the present disclosure;

FIG. 5 is a schematic diagram II of the implementation of the present disclosure;

FIG. 6 is a schematic diagram III of the implementation of the present disclosure;

FIG. 7 is a schematic diagram IV of the implementation of the present disclosure;

FIG. 8 is a schematic diagram V of the implementation of the present disclosure;

FIG. 9 is a schematic diagram VI of the implementation of the present disclosure;

FIG. 10 is a schematic diagram VII of the implementation of the present disclosure;

FIG. 11 is a schematic diagram VIII of the implementation of the present disclosure;

FIG. 12 is a schematic diagram IX of the implementation of the present disclosure;

FIG. 13 is a schematic diagram X of the implementation of the present disclosure;

FIG. 14 is a schematic diagram XI of the implementation of the present disclosure;

FIG. 15 is a schematic diagram XII of the implementation of the present disclosure;

FIG. 16 is a schematic diagram XIII of the implementation of the present disclosure; and

FIG. 17 is a schematic diagram XIV of the implementation of the present disclosure.

### DETAILED DESCRIPTION OF PREFERRED EMBODIMENTS

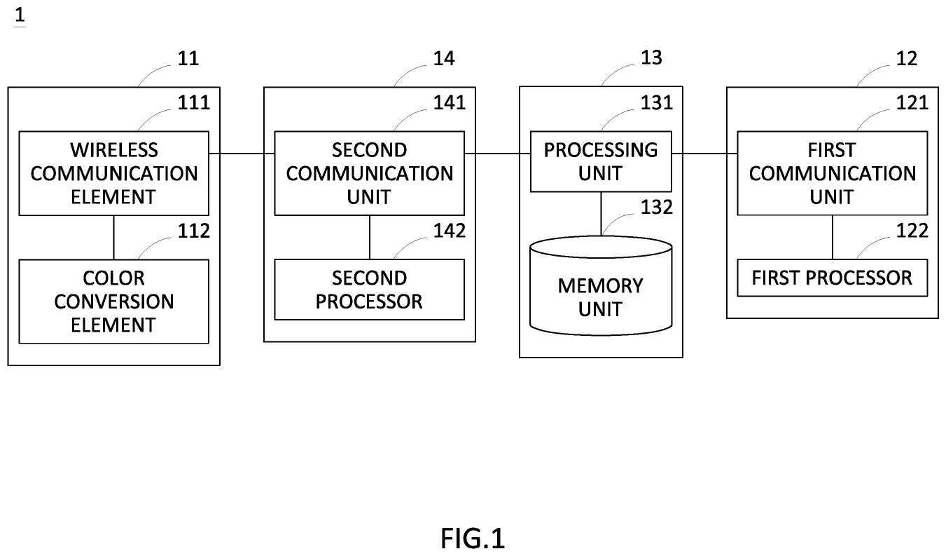

Referring to FIG. 1, a system 1 for encrypted multimedia information management according to the present disclosure includes a sensing device 11, a first information device 12, a server 13, and a second information device 14.

The sensing device 11 includes a wireless communication element 111, such as an induction coil of near-field communication or an induction coil of radio frequency identification, etc. The wireless communication element 111 stores an identification code of the sensing device 11. When the wireless communication element 111 is detected and read, for example, when a decryption request is received, the identification code may be sent to the device that issued the decryption request. In addition, the sensing device 11 may also include a color conversion element 112. The color conversion element 112 may be, for example, a light-emitting element, such as a light-emitting diode light source, an electrochromic material, an electronic ink, etc. The color conversion element 112 can change color or emit light when the wireless communication element 111 is read and sensed. For example, when the wireless communication element 111 is successfully read, the color conversion element 112 emits light to display color, change color, or present different patterns, etc. It is preferred that the sensing device 11 is formed in a card shape. Moreover, the color conversion element 112 is a transparent light-emitting diode formed on the periphery of the card.

The first information device 12 can be, for example, one of a mobile phone, a tablet computer, a personal computer, etc. It is preferred that the first information device 12 is a portable mobile device and is fitted with an application program APP to perform subsequent technical features. The first information device 12 includes a first communication unit 121 and a first processor 122. The first communication unit 121 is informationally connected with the sensing device 11 and the server 13 for obtaining the identification code of the sensing device 11. In addition, the first processor 122 may generate a public key by use of a first key generation function based on an identity feature of a second user. The public key can be employed to encrypt the multimedia information for the first time. The first key generation function can, for example, apply encryption algorithms such as RSA, ElGamal, Rabin, DSA, ECDSA, etc. and completes the association of the first encrypted multimedia information with the identification code. Thereafter, the multimedia information and a time condition are uploaded to the server 13 through the first communication unit 121. It is preferred that the first communication unit 121 can also set a limit on the number of browsing times and upload them to the server 13 at the same time.

The server 13 includes a processing unit 131 and a memory unit 132. The processing unit 131 completes the information connection with the first information device 12 and the second information device 14. The memory unit 132 can store the received information, such as multimedia information, identification code, private key, etc. The processing unit 131 is provided for generating a key with symmetric encryption based on a second key generation function by use of the input data consisting of the identification code and the time condition. The second key generation function can be, for example, time-based one-time password. The key is employed to encrypt the first encrypted multimedia information for the second time. The processing unit 131 is also employed for filtering out the corresponding multimedia information by use of the identification code. When it is needed for decryption, the processing unit 131 employs the key generated based on the second key generation function by use of a current time point and the identification code to conduct a first decryption. After the first decryption is completed, a private key sent by the second information device 14 is used for the second decryption. After the decryption is completed, the multimedia information is sent to the second information device 14. It is preferred that the server 13 can delete the multimedia information or reject the decryption request based on the aforementioned limit on the number of browsing times. The processing unit 131 may be, for example, one or a combination of central processing unit, graphics processing unit, micro processing unit, or micro control unit. The memory unit 132 can be, for example, one or a combination of solid state disk/drive, hard disk drive, static random access memory, random access memory, or cloud drive, but not limited thereto.

The second information device 14 can be, for example, one of a mobile phone, a tablet computer, a personal computer, etc. It is preferred that the second information device 14 is a portable mobile device and is fitted with an application program APP to perform subsequent technical features. The second information device 14 includes a second communication unit 141 and a second processor 142. The second communication unit 141 is informationally connected with the sensing device 11 and the server 13 for obtaining the identification code of the sensing device 11. In addition, the second processor 142 can generate a private key corresponding to the aforementioned public key by use of the first key generation function according to the identity feature. Thereafter, the identification code and the private key are sent to the server 13 through the second communication unit 141.

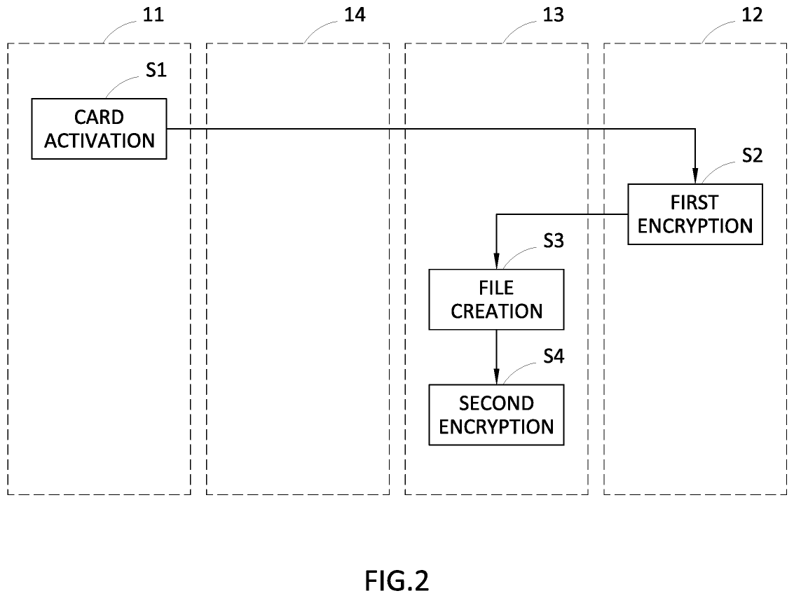

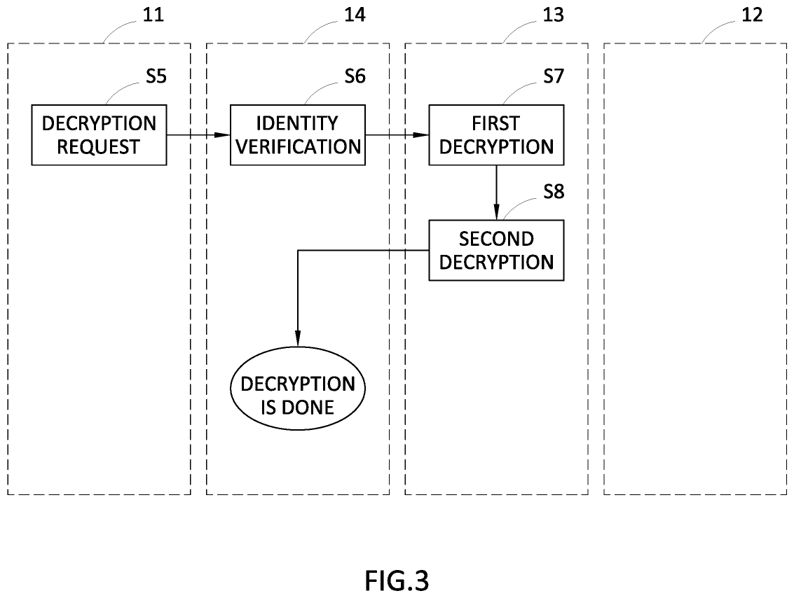

As shown in FIG. 2 and FIG. 3, the encrypted multimedia information management method of the present disclosure is divided into two parts. One is to encrypt the multimedia information M, and the other is to decrypt the multimedia information M. Details thereof are described as follows:

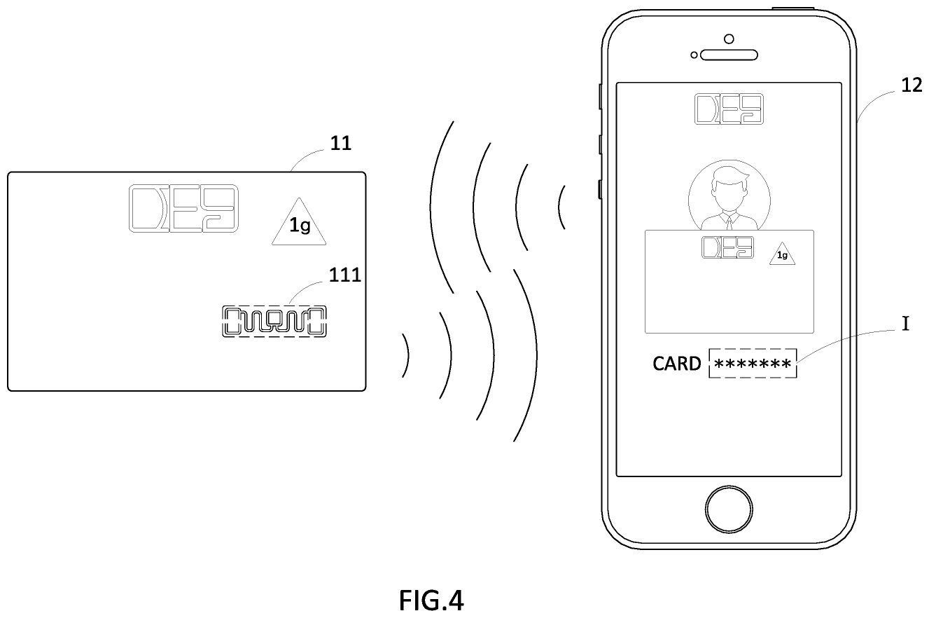

Step S1 of card activation: a first information device 12 sends an identification code request to a sensing device 11; after receiving it, the sensing device 11 returns an identification code I to the first information device 12. The first information device 12 can transmit data to the wireless communication element 111 based on near-field communication or radio frequency identification through the first communication unit 121. As shown in FIG. 4, a first user uses the first information device 12 to capture the identification code I from the sensing device 11 in the form of a card. If the sensing device 11 successfully receives the identification code request I, it is preferred that the sensing device 11 conducts the change of colors or emits a light.

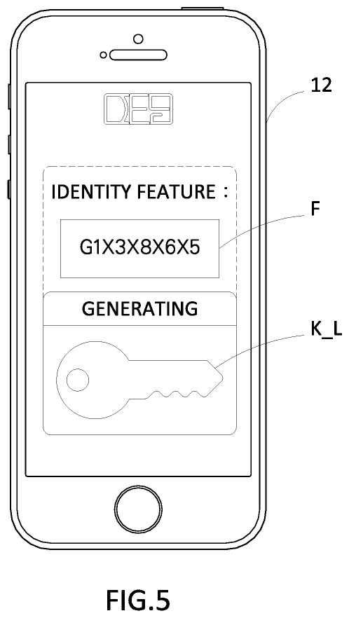

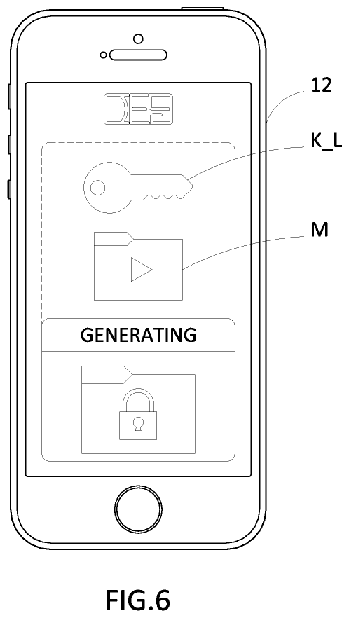

Step S2 of first encryption: the first information device 12 generates a public key K_L based on an identity feature F of a second user. The identity feature F can be, for example, a fingerprint, a phone number, personal information (such as ID number, birthday, special anniversary, etc.), or a password set by yourself. As shown in FIG. 5, the first information device 12 generates a public key K_L with asymmetric encryption by using the even digits of the second user's ID number through a first key generation function. As shown in FIG. 6, the multimedia information M is encrypted for the first time by using the public key K_L.

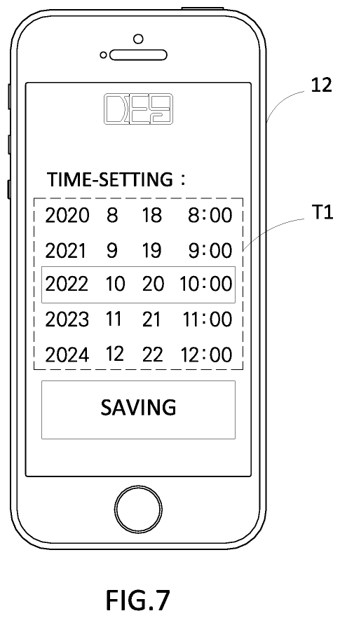

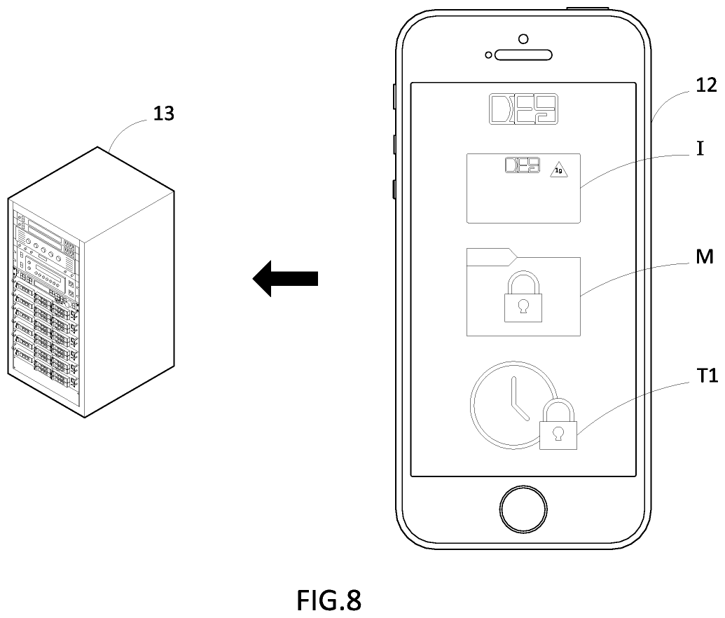

Step S3 of file creation: the first information device 12 uploads the multimedia information M, the identification code I, and a time condition T1 (having completed the step S3 of file creation) to a server 13, and associates the multimedia information M with the identification code I. As shown in FIG. 7, the first user sets a time condition T1 by the first information device 12. As shown in FIG. 8, the first information device 12 uploads the time condition T1, the first encrypted multimedia information M, and the identification code I to the server 13. It is preferred that the first information device 12 may further transmit a limit of the number of browsing times to the server 13.

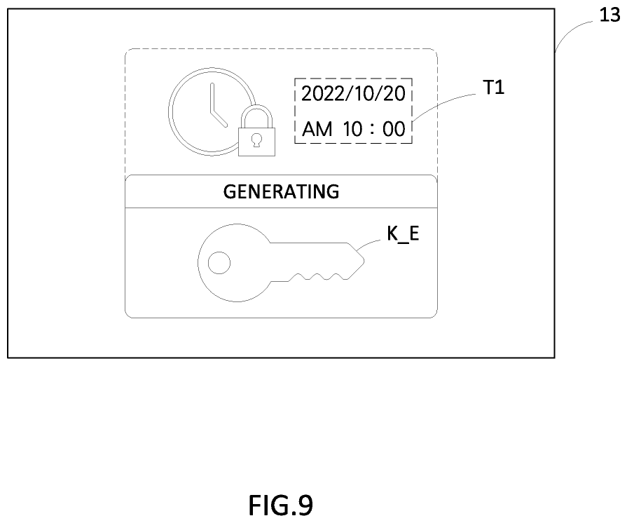

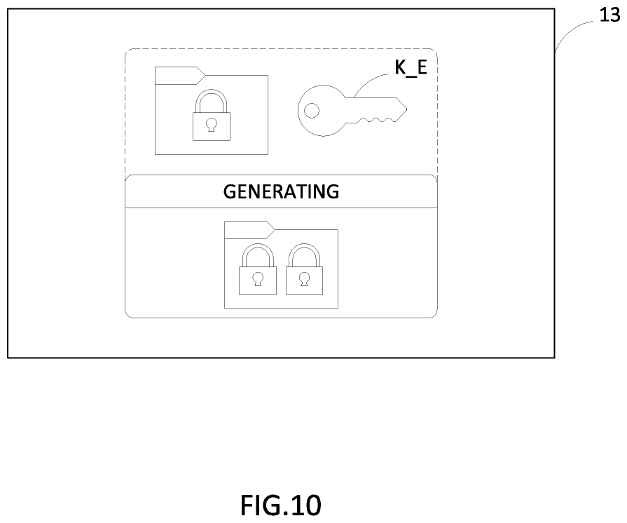

Step S4 of the second encryption: As shown in FIG. 9, the server 13 provides the identification code I and the time condition T1 as input data, and generates a key K_E with symmetric encryption by use of a second key generation function. As shown in FIG. 10, the multimedia information M that has been encrypted for the first time is encrypted for the second time by the server 13 by use of the key K_E.

The above is the step for the first user to encrypt the multimedia information M to be sent to a second user by using the first information device 12. When the second user obtains the sensing device 11 and wants to decrypt and receive the multimedia information M, the following steps should be continued (see FIG. 3):

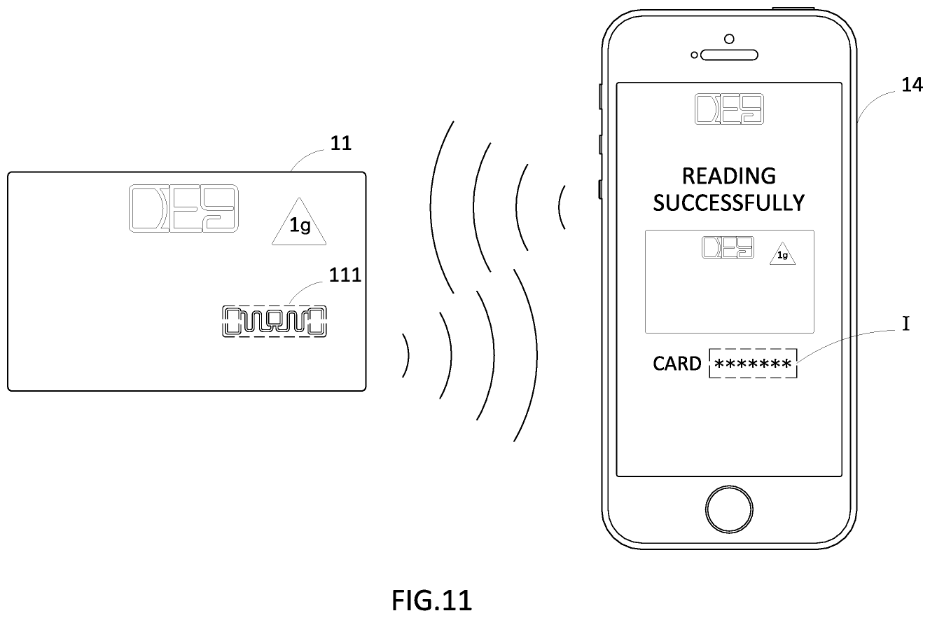

Step S5 of decryption request: as shown in FIG. 11, a second information device 14 sends an identification code request to the sensing device 11. After receiving it, the sensing device 11 returns an identification code I to the second information device 14. It is preferred that the sensing device 11 changes color or emits light if the sensing device 11 receives the request for the identification code I successfully.

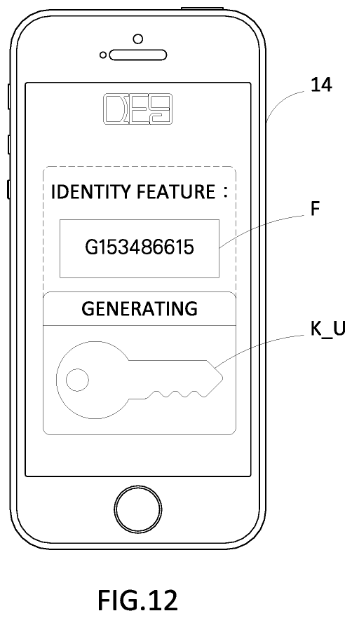

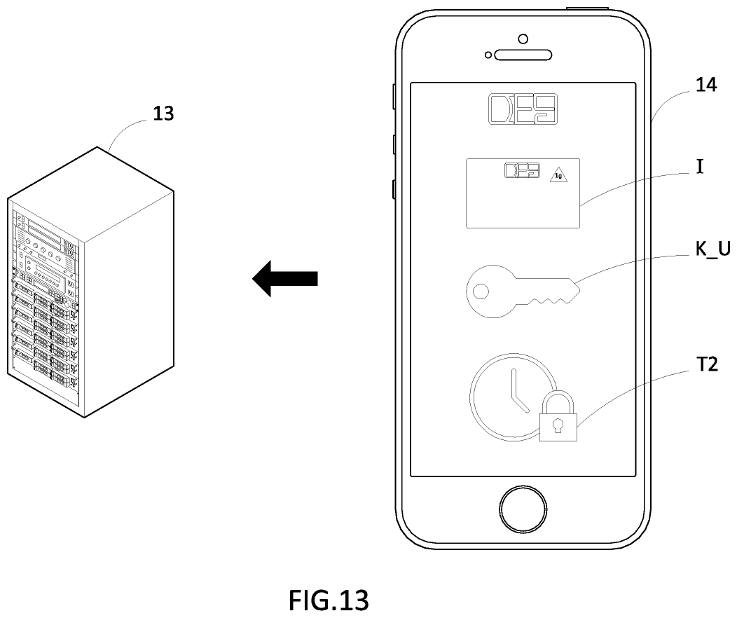

Step S6 of identity verification: the second information device 14 uses an identity feature F of the second user as input data, and generates a private key K_U corresponding to the public key K_L by use of the first key generation function. The second information device 14 sends the private key K_U to the server 13, and the server 13 filters out the corresponding multimedia information M according to the identification code I. As shown in FIG. 12, the second information device 14 is used to input the identity feature F (such as the identity card number) of the second user for generating the private key K_U according to the public key K_L. As shown in FIG. 13, the current time point T2, the identification code I, and the private key K_U are transmitted to the server 13.

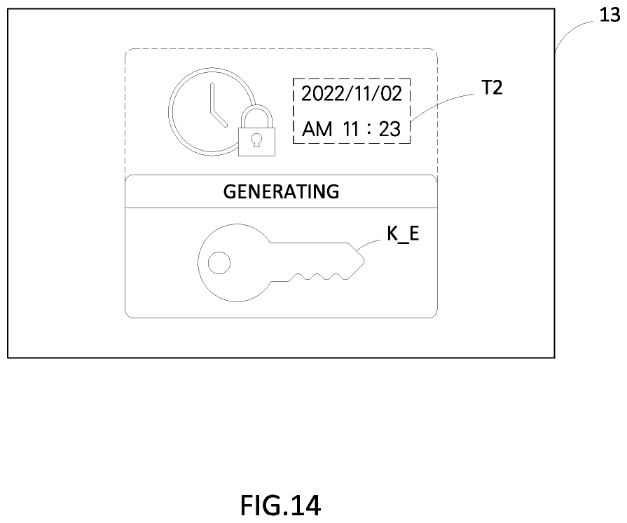

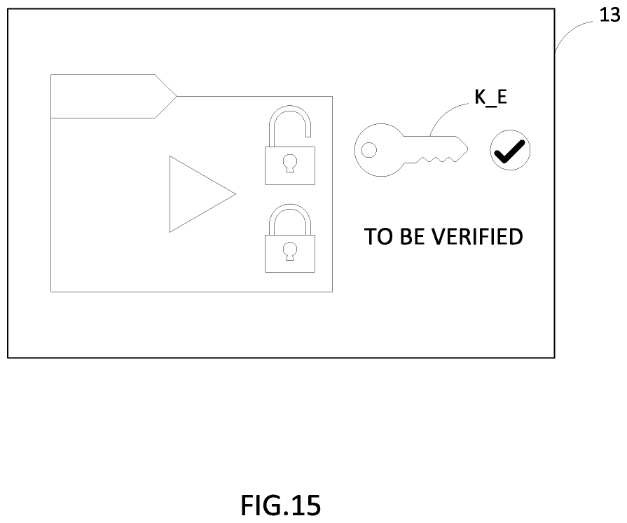

Step S7 of first decryption: referring to FIG. 14 to FIG. 15, the server 13 uses the identification code I and the current time point T2 as input data for generating a key K_E by use of the second key generation function. Meanwhile, the key K_E is used for the first decryption.

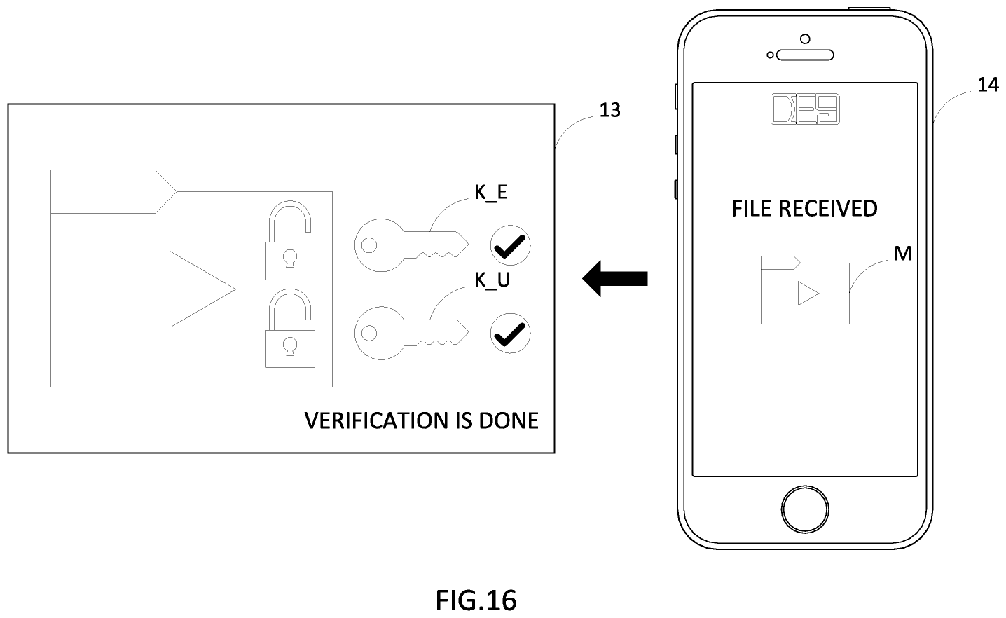

Step S8 of second decryption: as shown in FIG. 16, the server 13 uses the private key K_U to decrypt the multimedia information M for the second time. After decryption, the multimedia information M is transmitted to the second information device 14. When the number of times the server 13 transmits the multimedia information M to the second information device 14 reaches the limit of the number of browsing times, the server 13 deletes the multimedia information M or rejects the decryption request of the multimedia information M.

An example of a first situation (birthday congratulations) is taken as follows. If user A wants to send a birthday congratulatory video to user B, the user A can first record the birthday congratulation video with the first information device 12. The user A also holds a sensing device 11 and captures the identification code I of the sensing device 11. The user A uses the identity feature F (such as the name of the user B) to generate the public key K_L, and then encrypts the birthday congratulation video for the first time. The birthday of the user B is set as the time condition T1 which is transmitted to the server 13 together with the birthday congratulatory video, the identification code I, and the user A after the first encryption is completed. The identification code I and the user B are used as input data for generating a key K_E and performing the second encryption. In this way, the setting of the birthday congratulation video is completed. On the birthday, the user B can take out the sensing device 11 gifted by user A, and the second information device 14 owned by the user B sends a decryption request to the sensing device 11 for capturing the identification code I. Thereafter, the user B input the identity feature F (such as the name of the user B) through the second information device 14 for generating a private key K_U corresponding to the public key K_L. Then, the identification code I, the private key K_U, and the current time point T2 are transmitted to the server 13 through the second information device 14. The server 13 uses the identification code I to filter out the corresponding birthday congratulation video. Meanwhile, the time point T2 and the identification code I received by the server 13 are used for generating the key K_E, thereby performing the first decryption. After the decryption is completed, the private key K_U received by the server 13 is used for performing the second decryption. After the second decryption is successfully done, the server 13 sends the birthday congratulation video to the second information device 14 of the user B. In this way, the birthday congratulation video can be played by the second information device 14.

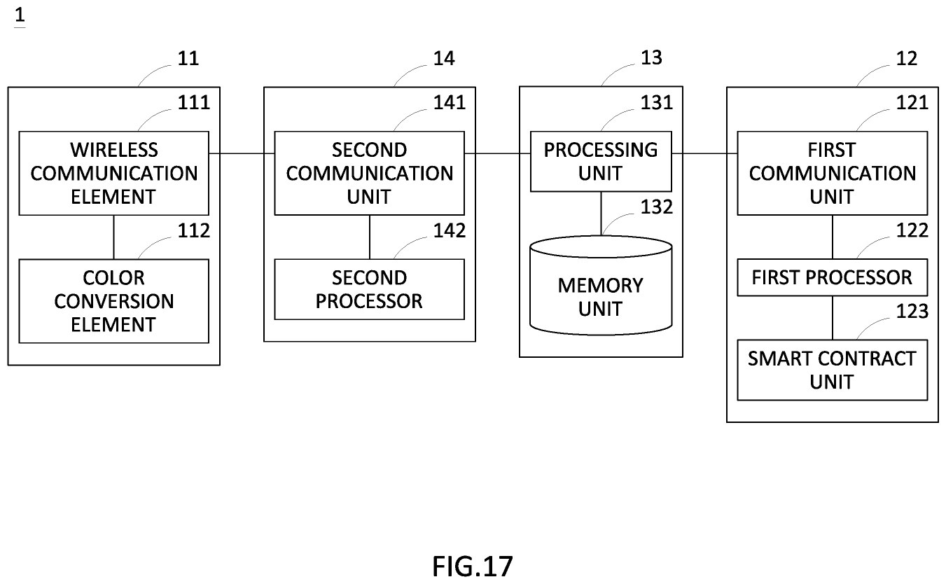

Referring to FIG. 17, the first information device 12 of the present disclosure further includes a smart contract unit 123. The smart contract unit 123 is used to record a smart contract with a contract private key as a time condition. Also, a public private key corresponding to the contract private key is recorded. Before the smart contract is performed, the server 13 performs the second encryption with the public private key. Therefore, the multimedia information M cannot be decrypted for the first time before the contract is performed. In settling the smart contract, the server 13 first decrypts the multimedia information M with the contract private key, and then re-encrypts it for the second time with the time when the smart contract is performed. In this way, it can be achieved that after the smart contract is performed, the multimedia information M can be decrypted for the second time, or even completely decrypted, and the content of the multimedia information M can be obtained.

The second situation will be depicted below, with a will as an example. Another user C wants to write a will and use a living contract to plan things after death. First, a public will is created through a living contract and the system/method of the present disclosure. Multimedia information for each beneficiary is also established. The public will records the identity feature (such as: specific memories, secrets, or agreements between each beneficiary and the user C) of each beneficiary's multimedia information to be decrypted, thereby generating a public key to encrypt each multimedia information for the first time. In addition, the smart contract records the public will, the time condition, and a contract private key. The smart contract is set to be performed when user C dies. Moreover, a smart public private key is used to encrypt the multimedia information for the second time. When the user C dies, the smart contract is performed, the server obtains the contract private key, decrypts the multimedia information, and re-encrypts for the second time based on the time condition recorded by the smart contract as “start now”. In this way, the user C does not have to worry that the will be disclosed in advance and the will be leaked intentionally or negligently.

The present disclosure can be applied to the transmission of congratulatory multimedia information, daily messages, etc. It includes asymmetric encryption public and private keys by use of user identity feature and symmetric encryption keys by use of physical sensing devices and time conditions. By encrypting the multimedia information to be transmitted for the first time with the public key and then with another key for the second encryption, it can ensure that the server cannot be decrypted by the identification code and time conditions. Moreover, when encrypted multimedia information is stolen, it cannot be decrypted only through time conditions and identity features. The second user cannot open the multimedia information at an incorrect time, so it can be ensured that only the second user who owns the sensing device can open the multimedia information at a specified time. In addition, the present invention further includes a smart contract, which can re-encrypt and decrypt multimedia information when triggered by a specified situation, thereby greatly expanding the scope of application. Accordingly, after the present disclosure is implemented, it can indeed achieve the purpose that the multimedia information content can be opened only in a specific time interval. Meanwhile a good encryption protection is achieved.

### REFERENCE SIGN

1 system for encrypted multimedia information management
11 sensing device
111 wireless communication element
112 color conversion element
12 first information device
121 first communication unit
122 first processor
123 smart contract unit
13 server
131 processing unit
132 memory unit
14 second information device
141 second communication unit
142 second processor
S1 card activation
S2 first encryption
S3 file creation
S4 second encryption
S5 decryption request
S6 identity verification
S7 first decryption
S8 second decryption
I identification code
F identity feature
T1 time condition
T2 time point
K_L public key
K_U private key
K_E key
M Multimedia Information

What is claimed is:

1. A system for encrypted multimedia information management for a second user to check a multimedia information of a first user, comprising:
a sensing device having a wireless communication element storing an identification code;
a first information device informationally connected with the sensing device and a server, and having a first communication unit for obtaining the identification code of the sensing device, the first information device further having a first processor for generating a public key by use of a first key generation function based on an identity feature of the second user, wherein the public key generated by use of the first key generation function is employed to encrypt the multimedia information for the first time, associate the multimedia information with the identification code, and to upload the multimedia information and a time condition to the server; and
a second information device informationally connected with the sensing device and the server, and having a second communication unit for obtaining the identification code, the second information device further having a second processor for generating a private key corresponding to the public key by use of the first key generation function based on the identity feature, wherein the second information device is employed to transmit the identification code and the private key of the second information device to the server,
wherein the server comprises a memory unit for storing the identification code, the time condition, and the multimedia information and further comprises a processing unit for generating a key based on a second key generation function by use of the identification code and the time condition, and wherein the key is employed to encrypt the first encrypted multimedia information for the second time, and wherein the processing unit is employed for filtering out the corresponding multimedia information by use of the identification code, and wherein the processing unit employs the key generated based on the second key generation function by use of a current time point and the identification code to decrypt the multimedia information for the first time, and wherein the processing unit conducts a second decryption with the private key, and wherein, after the decryption is completed, the multimedia information is sent to the second information device.

2. The system for encrypted multimedia information management as claimed in claim 1, wherein the first information device further comprises a smart contract unit for recording a smart contract with a contract private key as the time condition and sending it to the server, and wherein the server first performs a second encryption with a public private key, and wherein, when the smart contract is performed, the server first decrypts the multimedia information with the contract private key, and then re-encrypts it for the second time with the time when the smart contract is performed.

3. The system for encrypted multimedia information management as claimed in claim 1, wherein the server encrypts the time condition or the time point with a time-based one-time password algorithm.

4. The system for encrypted multimedia information management as claimed in claim 1, wherein the first information device is used for sending a limit of browsing times to the server, and wherein, when the number of times the server transmits the multimedia information to the second information device reaches the limit of browsing times, the server deletes the multimedia information or rejects the decryption request of the multimedia information.

5. The system for encrypted multimedia information management as claimed in claim 1, wherein the sensing device includes a color conversion element, and wherein, when the sensing device receives the identification code request successfully, the color conversion element changes color or emits light.

6. The system for encrypted multimedia information management as claimed in claim 1, wherein the sensing device is formed in the shape of a card.

7. The system for encrypted multimedia information management as claimed in claim 5, wherein the sensing device is formed in the shape of a card, and wherein the color conversion element is a transparent light-emitting diode formed on the periphery of the card.

8. A method for encrypted multimedia information management for a second user to check a multimedia information of a first user, comprising the following steps of:
card activation, wherein a first information device sends an identification code request to a sensing device, and wherein the sensing device returns an identification code to the first information device;
first encryption, wherein the first information device generates a public key based on an identity feature of the second user by use of a first key generation function and encrypt the multimedia information with the public key for the first time;
file creation, wherein the first information device uploads the first encrypted multimedia information and a time condition to a server and associates the multimedia information with the identification code;
second encryption, wherein, based on the identification code and the time condition, the server encrypts for the second time the multimedia information that has been encrypted for the first encryption;
decryption request, wherein a second information device sends a decryption request to the sensing device and obtains the identification code;
identity verification, wherein the second information device transmits the identification code and a private key of the second information device to the server and the server filters out the corresponding multimedia information with the identification code;
first decryption, wherein the server performs a first decryption based on a current time point and the identification code; and
second decryption, wherein the server performs a second decryption with the private key and transmits the multimedia information to the second information device after the decryption is completed.

9. The method for encrypted multimedia information management as claimed in claim 8, wherein, in the step of file creation, a smart contract is used as the time condition, and wherein, in the second encryption step, the server first performs the second encryption with a public private key, and wherein, when the smart contract is performed, the server first decrypts the multimedia information with the contract private key, and then re-encrypts it for the second time with the time when the smart contract is performed.

10. The method for encrypted multimedia information management as claimed in claim 8, wherein the server encrypts the time condition or the time point with a time-based one-time password algorithm.

11. The method for encrypted multimedia information management as claimed in claim 8, wherein, in the step of file creation, the first information device sends a limit of browsing times to the server, and wherein, in the second decryption, when the number of times the server transmits the multimedia information to the second information device reaches the limit of browsing times, the server deletes the multimedia information or rejects the decryption request of the multimedia information.

12. The method for encrypted multimedia information management as claimed in claim 8, wherein, in the step of card activation or decryption request, the color conversion element changes color or emits light when the sensing device receives the identification code request successfully.
